(19) United States
(12) Patent Application Publication
(10) Pub. No.: US 2023/0284859 A1
(43) Pub. Date: Sep. 14, 2023

(54) CLEANING PAD FOR TREATING SURFACES

(71) Applicant: Ulrich POHLMANN, Ahaus (DE)

(72) Inventor: Ulrich POHLMANN, Ahaus (DE)

(21) Appl. No.: 18/004,344

(22) PCT Filed: Jul. 7, 2021
(86) PCT No.: PCT/DE2021/100594

§ 371 Date: Jan. 5, 2023

(30) Foreign Application Priority Data
Jul. 7, 2020 (DE) 10 2020 117 922.7

(51) Int. Cl. A47L 13/16; A47L 13/42

(52) U.S. Cl. CPC A47L 13/16; A47L 13/42

(57) ABSTRACT

The invention relates to a cleaning pad (100) for treating surfaces, in particular smooth surfaces, wherein the cleaning pad (160) has an elastically deformable core (1) and a cleaning cover (2) surrounding said core, wherein a container (4), which has a storage part (6) and a neck (7) in which a spray head (8) is installed, is embedded into the interior of the core (1), wherein an opening (9) above which at least part of the neck (7) is positioned is located in the cleaning cover (2) above the side of the container (4) facing the neck (7). In order to simplify the manufacture of the cleaning pad (100), according to the invention the storage part (8) can be passed through the opening (9), wherein the cross-sectional area of the opening (9) corresponds at least to the cross-sectional area of the storage part (6).

The invention relates to a cleaning pad for treating, in particular smooth surfaces according to the preamble of claim 1, and a manufacturing process according to the preamble of claim 17.

A cleaning pad of the aforementioned type can be found in DE 295 08 348 U1.

A cleaning pad with a tube piece integrated into the pad is disclosed in AT 226 412.

The cleaning pad previously known from DE 295 08 348 U1 has a bag-shaped cleaning cover that contacts the surface to be cleaned with one of its outer sides during wiping. The pad is provided with a foam core for cushioning, which further has a container in its interior, which in turn has an approximately cube-shaped supply part and an adjoining, closable neck. DE 295 08 348 U1 provides that cleaning liquid is conveyed within the container with a hollow tube to a spray head screwed onto the neck, which is designed as a conventional valve spray head, the valve head actuating a valve and also containing a spray nozzle 8 which sprays out the cleaning liquid laterally. It is therefore not necessary to use both a supply bottle with a cleaning agent and a cleaning pad separately for cleaning. It is rather sufficient to refill the supply bottle integrated in the cleaning pad as necessary, which advantageously reduces the number of cleaning utensils required.

However, a disadvantage of this previously known cleaning pad is that the supply bottle is arranged quite voluminously and bulky in the core, since the outer surfaces of the supply part run plane-parallel to the outer surfaces of the core which substantially fills the cleaning pad. Due to this, the production of the cleaning pad is quite complex, as several blanks of the core are needed to encase the supply bottle over a large area. Also, the supply part cannot be easily replaced, which is desirable, for example, if it is damaged.

The invention is therefore based on the problem of achieving an improvement here.

The invention achieves this object by means of a cleaning pad with the features of claim 1 and by means of a method with the features of claim 17. With regard to further advantageous refinements and developments, reference is made to claims 2 to 16 and 17 to 18.

Since the invention further provides a generic cleaning pad for treating in particular smooth surfaces in such a way that the supply part can be passed through the opening, the cross-sectional area of the opening corresponding at least to the cross-sectional area of the supply part, a structurally simple production of the cleaning pad and a rapid replacement of the supply part is ensured. For this purpose, the cross-sectional area of the opening must be sufficiently dimensioned so that the supply part can be guided through the opening into the core. To make the cleaning pad visually presentable, it is advantageous that the cross-sectional area of the supply part and the cross-sectional area of the opening are congruent. The supply part can be guided through the opening and pressed into the core. Alternatively, the core is provided with a cavity, which can be formed by punching or welding. Alternatively, the core can also be split in two, i.e. in two halves, but assembled, and thus also the cavity. In order to ensure a tight fit of the supply part in the cavity, it is useful that the cross-sectional area of the supply part and the cross-sectional area of the cavity are congruent, so that the supply part can be guided with a precise fit into the cavity. Conveniently, at least part of the outer surface of the container and/or at least part of the inner surface of the cavity is provided with an adhesive.

An advantageous further development of the invention provides that the cleaning cover has an inwardly curved shape at its edges, which advantageously enables an improved taking of the cleaning pad into the hand. The curved shape can also have a straight section in the middle of the edges. In order to make the cleaning pad more resistant and thus also to improve its quality, a practicable variant of the invention provides that at least a part of the cleaning cover is leather-like.

A further practicable variant of the invention provides that the cleaning cover consists of two material blanks which enclose the core between them and are joined to one another at an edge area surrounding the core by means of at least one adhesive and/or weld seam, wherein at least one of the material blanks (11, 12) is coated with an activatable or activated adhesive material on its surface facing the core (1), at least in its edge area (13). This enables stable surface bonding of the edge areas, resulting in very good adhesion that holds the material blanks together in a stable manner even in continuous operation.

In particular, the adhesive material can be thermally activated or is thermally activated to form an adhesive or weld seam. Then the adhesive material is initially non-adhesive in production and is only activated by placing a corresponding stamp, which in particular is provided with a high-frequency generator. That simplifies the production.

It is particularly advantageous if the seam is closed up to the outermost edge and has a width of at least two millimetres. In particular, a width of five millimetres is also possible. By closing to the outermost edge, there is no attempt to tear apart the two material blanks adhering to one another at the seam. In the washing machine, for example, no lye can penetrate between the material blanks of the cover. The stable edge several millimetres wide also provides a strong adhesion surface on the one hand, and on the other hand also a lettering surface that can be printed to the outermost edge without the lettering being blurred or rendered illegible by warping. For example, manufacturer information or washing instructions can be printed there. The value of the cleaning pad created in this way is significantly increased.

It is particularly advantageous for the adhesive material to be applied as an activatable layer to at least one of the material blanks on its surface facing the core. Such a large-area layer can be created simply by production technology in such a way that at least one of the material blanks is underlaid with an adhesive gauze, in particular over its entire area, on its surface facing the core.

The adhesive gauze can have a flexible, mesh-like structure that can be stretched elastically in all directions. There are practically no requirements placed on their mechanical stability. In particular, the adhesive gauze can be formed by an inherently irregular non-woven layer without any preferred directions in the material. Such a material can be bought very cheaply and has only a minimal dead weight.

Such an adhesive gauze is also easy to process and, since it does not yet stick without activation, it can be very advantageously connected to the material of the respective material blank by rolling. Sufficient adhesion to the (not yet cut or punched) web-like material of the material blank is achieved solely by the rolling process.

The seam can be achieved by activating the at least one adhesive layer by means of ultrasound, high-frequency, cold or hot bonding.

Both sides of the cleaning pad can be antibacterial, at least limited virucidal and further different for great flexibility, for example one side covered with microfibre for wet cleaning and one side covered with synthetic leather for drying. A uniform cover (for example as leather, textile leather or synthetic fibre) is also possible as an alternative. The material blanks can be made of a non-woven, e.g., based on polyamide or polyurethane or made of velour or terry cloth or knitted fabrics with different cleaning properties or antifogging properties. It is particularly advantageous if at least one of the material blanks consists of strongly cleaning and dirt-absorbing microfibre material. A material blank made in particular from synthetic leather (imitation leather) can have numerous continuous openings. The synthetic leather can have a velour-like, soft, velvety feel, which visually and haptically corresponds to real suede.

The core itself can advantageously consist of a permanently elastic, open-cell soft foam, for example polyurethane soft foam, or a combination of soft foam and non-woven material.

Recycling granulate, for example from tire scraps, is also possible. The material for the core can be in the form of a bulk fill or from a block. In addition, the core can consist of at least two soft material layers, of which one layer is made of soft foam and the other is made of a textile material, such as cushioning wadding. Silicone foam or biodegradable viscose foam can also be used as the soft foam.

In particular, at least one image, logo, advertising message or the like can be applied in one or more colours to one or both sides, up to the outermost edge, beyond the adhesive or weld seam. Image, logo, lettering or advertising slogan can be applied in one or more colours as well as photo printing or embossing with the help of a printing process known per se.

In a manufacturing process, it is initially important if two material webs are initially provided, at least one of which is provided with an elastic layer of activatable adhesive material and is only cut out or punched out into a material blank in the coated state. The connection with the layer of adhesive material is then possible in a particularly simple and inexpensive manner.

Furthermore, one of the material blanks can then be placed in a box, with an in particular cuboid, elastically deformable core being placed on this material blank and the second material blank on the core, the first and second material blanks laterally projecting beyond the core and subsequently both material blanks are pressed against one another while enclosing the core and in the process the adhesive layer is dissolved, and the material blanks are glued and/or welded to one another. This results in the wide edge area, which is stable and closed to the outside and which can also be labeled.

The welding and/or gluing can be activated simply and reliably by high-frequency exposure. This form of bonding creates an even transition between the joined materials and thus guarantees very high seam strengths. There are no gaps and spaces where dirt particles can collect, which negatively affect the durability of the cleaning pad. In addition, the seam can be made airtight and watertight.

During the production of the cleaning pad, the core should be provided with a cavity and at least one material blank should be provided with an opening before or after bonding and/or welding, and after bonding and/or welding, the supply part should be guided through the opening into the cavity.

Further advantages and features of the invention emerge from the exemplary embodiments of the subject matter of the invention shown in the drawing and described below.

### BRIEF DESCRIPTION OF THE DRAWINGS

FIG. 1 an embodiment of the cleaning pad according to the invention in a perspective view;

FIG. 2 the cleaning pad of FIG. 1, the edges of which have an inwardly curved shape, and

FIG. 3-FIG. 4 a schematic overview of the manufacturing process of the cleaning pad according to the invention.

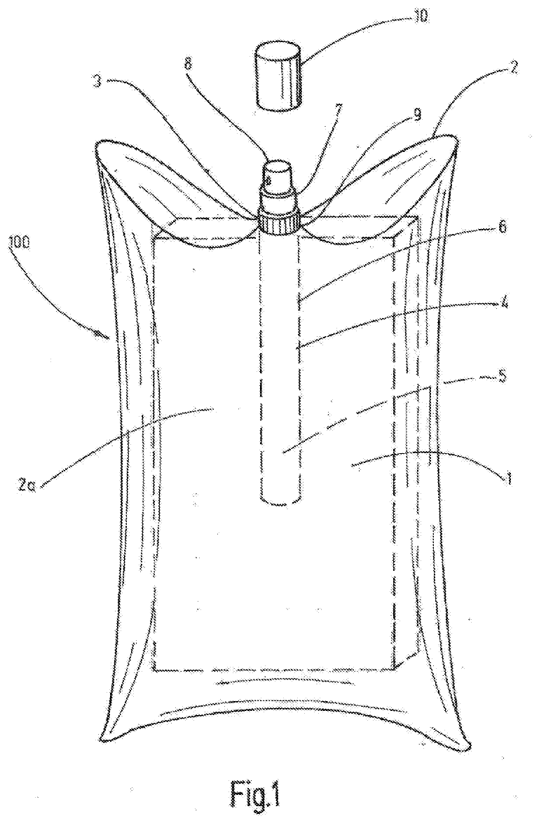

FIG. 1 shows a cleaning pad which is provided with the reference sign 100 and which has a core 1 of elastically deformable material, such as predominantly open-pored polyurethane soft foam, and a cleaning cover 2 enclosing this on the outside.

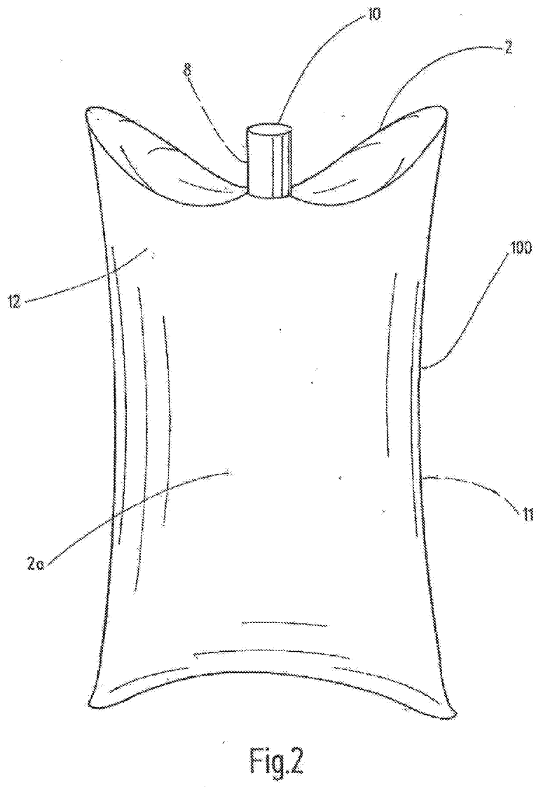

As is further illustrated in FIG. 2, the cleaning cover 2 consists of two flat, congruent material blanks 11, 12, the blank 11 being made of microfiber and the blank 12 being made of artificial leather 2a. In addition to the materials mentioned, a large number of other materials can in principle be used. The choice of materials depends on the properties desired in each case. The material blanks 11, 12 are oversized in relation to the core 1 shown in FIG. 1 and are joined to one another in their outer edge region via a laterally protruding and in particular circumferential adhesive and/or weld seam. As FIG. 2 further shows, the cleaning pad 100, whose maximum length is approx. 12 cm and maximum width approx. 7 cm, is characterised by a special shape in that the cleaning cover 2 has an inwardly curved shape at its edges.

The material blank 12 is optionally made from a high-quality natural leather, for example from the finest, soft elk leather. So that the natural leather can be glued to the second material blank 11 made of microfibre terry cloth, it is provided that the leather material blank 12 on at least its surface facing the core 1, at least in the edge area, be coated with a thermally activated adhesive, in particular to be bonded over a large area with an adhesive gauze. This can be air and water permeable and have an overall disordered structure.

The cleaning pad 100 is used in particular to treat smooth surfaces, such as panes or painted surfaces, and can be used without cleaning agents, for example to remove moisture.

The two material blanks 11, 12 can have different cleaning properties, antifogging properties and/or colours. In particular, a material pairing of a microfibre layer and an artificial leather layer or a pairing of a polyester textile layer and an artificial leather layer is possible. Other textile and/or leather-like designs are also possible for the cleaning cover 12; in particular, a support made of synthetic or natural fibres coated with polyurethane can also be used as the synthetic leather-like side.

As FIG. 1 shows, a container 6 is inserted into the interior of the core 1, which has a supply part 4 made of plastic or glass that can be refilled with cleaning agent and a neck 7 provided with a thread 3, in which a spray head 8 is installed, where an opening 9 is located in the cleaning cover 2 above the side of the supply part 4 facing the neck 7, above which the neck 7 is arranged. The neck 7, which is enclosed in the opening 9, can be unscrewed via the thread 3, i.e. it is removable and interchangeably connected to the container 6.

In addition, the cleaning pad shown in FIG. 1 is provided with a protective cap 10 which can be placed on the spray head 8. FIG. 1 further illustrates that the supply part 4 can be passed through the opening 9. For this purpose, the cross-sectional area of the supply part 4, which is cylindrical in the embodiment shown in FIG. 1, and the cross-sectional area of the opening 9 are congruent, where the core 1 has a cavity 5 into which the container 6 with its supply part 4 is inserted with a precise fit. To ensure a tight fit of the supply part 4 in the core 1, the cross-sectional area of the container 6 and the cross-sectional area of the cavity 5 are also congruent.

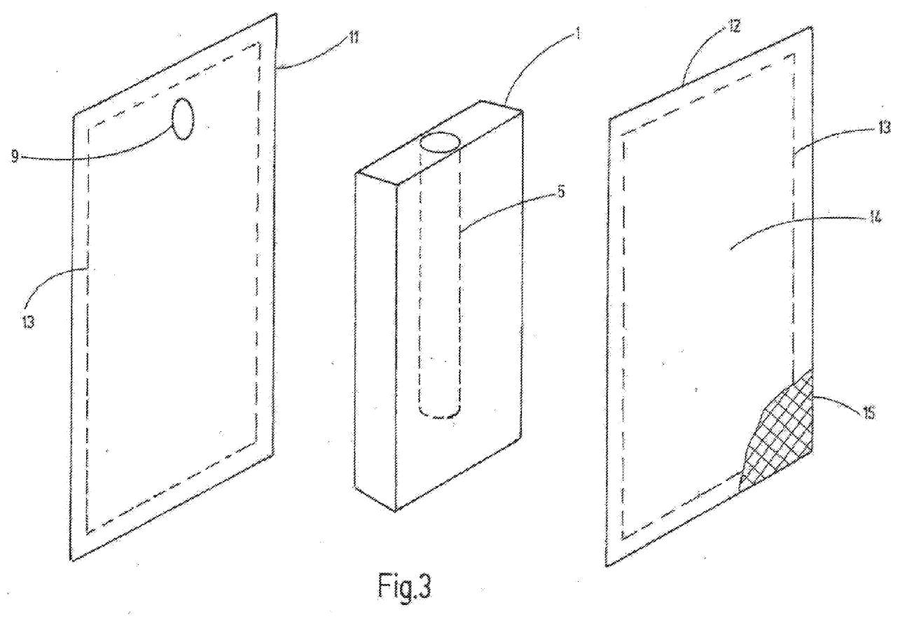

In order to produce such a wholly sponge-like cleaning pad 100, initially, as can be seen from FIG. 3, two material webs are provided for an upper and a lower layer to be formed, at least one of which is provided with an adhesive layer and, in the thus coated state, is cut out to form a material blank 11, 12, wherein a particularly cuboidal, elastically deformable core 1 is placed on a first material blank 11 and the second material blank 12, the material 12 of which is leather 14, is placed on the core 1, wherein the first and second material blanks 11, 12 protrude laterally beyond the core 1 at the edge 13 and wherein subsequently both material blanks 11, 12 are pressed against one another while enclosing the core 1 and in the process the adhesive layer 15 is dissolved and the material blanks 11, 12 are glued and/or welded to one another.

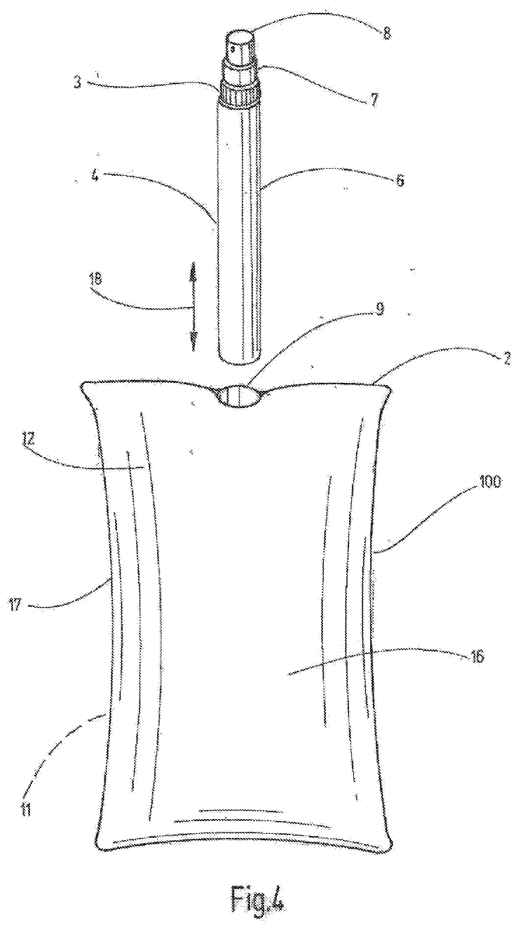

During the production of the cleaning pad, the core 1 is provided with a punched cavity 5 and at least one material blank 11,12 is provided with a punched opening 9 before or after bonding and/or welding. After bonding and/or welding, the container 6 with its supply part 4—as illustrated in FIG. 4—is guided through the opening into the cavity 5 shown in FIG. 3. The container 6 is interchangeable, as indicated by the arrow 18 in FIG. 4.

1. A cleaning pad (100) for treating smooth surfaces in particular, wherein the cleaning pad (100) comprises an elastically deformable core (1) and a cleaning cover (2) surrounding the core, a container (4) being introduced into the interior of the core (1), the container having a supply part (6) and a neck (7) into which a spray head (8) is built, there being an opening (9) in the cleaning pad (2) above the side of the container (4) facing the neck (7), at least part of the neck (7) being disposed above the opening
characterized in that
the supply part (6) can be passed through the opening (9), the cross-sectional area of the opening (9) being at least equal to the cross-sectional area of the supply part (6).

2. The cleaning pad according to claim 1,
characterized in that
the cross-sectional area of the supply part (6) and the cross-sectional area of the opening (9) are congruent.

3. The cleaning pad according to claim 1, characterized in that
the supply part (6) is cuboid, cylindrical, prism-shaped or is made in the shape of a hexagonal prism.

4. The cleaning pad according to claim 1,
characterized in that
the supply part (6) is bordered in the opening (9).

5. The cleaning pad according to claim 1,
characterized in that
the neck (7) is bordered in the opening (9).

6. The cleaning pad according to claim 1, characterized in that
the core (1) comprises a cavity (5) into which the supply part (6) is inserted.

7. The cleaning pad according to claim 6,
characterized in that
the cross-sectional area of the supply part (6) and the cross-sectional area of the cavity (5) are congruent.

8. The cleaning pad according to claim 6,
characterized in that
at least a part of the outer surface of the supply part (4) and/or at least a part of the inner surface of the cavity (5) is provided with an adhesive.

9. The cleaning pad according to claim 6, characterized in that
at least a part of the cleaning cover (2) is a type of leather.

10. The cleaning pad according to claim 6, characterized in that
the cleaning cover (2) has an inwardly-curving shape at the edges thereof.

11. The cleaning pad according to claim 6, characterized in that
the core (1) is split in two and half-cavities are made in the separate halves.

12. The cleaning pad according to claim 6,
characterized in that
the cleaning cover (2) consists of two material blanks (11, 12) which encapsulate the core (1) therebetween and which are connected together using at least an adhesive and/or a weld seam at an edge area (13) surrounding the core (1), at least one of the material blanks (11,12) being coated on the surface thereof facing the core (1) by an activatable or activated adhesive material at least in said edge area (13) of said at least one material blank.

13. The cleaning pad according to claim 12,
characterized in that
the adhesive material is thermally activatable or activated for forming a seam.

14. The cleaning pad according to claim 12 or 13, characterized in that
the seam is closed up to the outermost edge and has a width of at least two millimeters.

15. The cleaning pad according to claim 12, characterized in that
the adhesive material is applied as an activatable layer on at least one of the material blanks (11, 12) on the entire surface thereof facing the core (1).

16. The cleaning pad according to claim 15,
characterized in that
on the surface (8) facing the core (1) of at least one of the material blanks (11,12), an adhesive gauze material (15) is provided on the bottom.

17. A method for manufacturing a cleaning pad (100) according to claim 15, wherein
two material webs are prepared for an upper and a lower layer to be formed, at least one of said webs being provided with an adhesive layer and cut out into a material blank (11,12) so coated, wherein a core (1), in particular a cuboid, elastically deformable core, is placed onto a first material blank (11,12), and the second material blank (11,12) is placed onto the core (1), the first and the second material blanks (11,12) laterally protruding past the core (1), both material blanks (11,12) being then pressed together, encapsulating the core (1), and thereby dissolving the adhesive layer and gluing and/or welding the material blanks (11,12) together,
characterized in that
during the manufacture of the cleaning pad, the core (1) is provided with a cavity (5) and at least one material blank (11, 12) is provided with an opening before or after the gluing and/or welding, and after the gluing and/or welding the container (4) is passed through the opening (9) into the cavity (5).

18. The method according to claim 17,
characterized in that
the welding and/or gluing can be activated using high-frequency exposure.
